(19) United States
(12) Patent Application Publication
(10) Pub. No.: US 2007/0045898 A1
(43) Pub. Date: Mar. 1, 2007

(54) Method for making multicolored plastic mixed material of colored drawing

(76) Inventor: Deng-Ren Yang, Wufeng Shiang (TW)

Correspondence Address: CHARLES E. BAXLEY, ESQ., 90 JOHN STREET, THIRD FLOOR, NEW YORK, NY, 10038, US

(21) Appl. No.: 11/240,213

(22) Filed: Sep. 30, 2005

(30) Foreign Application Priority Data
Aug. 26, 2005 (TW) 094129349

(51) Int. Cl. B29C 39/12

(52) U.S. Cl. 264/245

(57) ABSTRACT

A method for making multicolored plastic mixed material of colored drawing comprises \textcircled{1} preparing a mold having at least two color areas, in each color area is formed an injection hole. \textcircled{2} injecting different colored plastic materials into the color areas of the mold via the injection holes during the same ejection molding process, and the different colored plastic materials will be mixed with each other in overlapping areas, the user can create different shaped color areas by changing position of the injection holes, time, speed and amount of plastic injection, and in the gradient lines will appear in the overlapping areas. \textcircled{3} unmolding a resultant multicolor plastic product from the mold.

### BACKGROUND OF THE INVENTION

1. Field of the Invention

The present invention relates to a method for making multicolored plastic product, and more particularly to a method for making multicolored plastic mixed material of colored drawing.

2. Description of the Prior Art

Most conventional plastic products made by ejection molding are single colored because the conventional method of producing the plastic products has the following shortcomings:

Firstly, the color and pattern of the conventional plastic product made by ejection molding can't be changed anymore once the color and pattern are fixed after the mold is finished, so that same mold can't produce a multicolor plastic product.

Secondly, a conventional multicolor plastic product only can be made by multiple molds and mold cores. For example, a triple color plastic product must be made by three separate steps of ejection molding, and in each step of ejection molding, a different mold and a different mold core should be used. Therefore, the production cost is high and the production efficiency is low.

Thirdly, another method of forming a multicolor plastic product is by spraying paint or printing color pattern on the surface of the plastic product, however, paint spray or print is not environment friendly and also makes the production process complicated.

The present invention has arisen to mitigate and/or obviate the afore-described disadvantages of the conventional multicolor plastic product production methods.

### SUMMARY OF THE INVENTION

The primary objective of the present invention is to provide a method for making multicolored plastic mixed material of colored drawing, wherein at least two different colored plastic materials are injected into a mold during the same injection molding process, at least two injection holes and color areas are arranged according to a predetermined pattern in order to create a multicolor plastic product with desired pattern, and the color areas are connected by a plurality of overlapping areas in which the plastic materials of two neighboring color areas are mixed with each other, after injection of the different colored plastic materials into the mold, different color areas each containing a different colored plastic material will be formed, and a gradient line formed by a mixture of the different colored plastic material will be created in the overlapping areas. The shape of the color areas of the multiple plastic product can be changed by changing the time, the speed and the amount of the colored plastic materials injection or by changing the position and the amount of the injection holes. Therefore, it not only can improve the appearance of the plastic product but also can reduce the mold development cost.

A method for making multicolored plastic mixed material of colored drawing in accordance with the present invention comprises the following steps:

\textcircled{1} preparing the mold having at least two color areas

in each color area is formed an injection hole, and the color areas are connected to one another by the overlapping areas in which the plastic materials of two neighboring color areas are mixed with each other;

\textcircled{2} injecting different colored plastic materials into the mold.

injecting the different colored plastic materials into the color areas of the mold via the injection holes during the same ejection molding process, and the different colored plastic materials will be mixed with each other in the overlapping areas, an user can create different shaped color areas by changing position of the injection holes, time, speed and amount of plastic injection, and in the gradient lines will appear in the overlapping areas.

\textcircled{3} unmolding a resultant multicolor plastic product from the mold.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a flow chart of showing the steps of for making multicolored plastic mixed material of colored drawing in accordance with the present invention;

FIG. 2 shows a mold for making multicolored plastic mixed material of colored drawing in accordance with a first embodiment of the present invention;

FIG. 3 shows a resultant multicolor plastic product made by the method for making multicolored plastic mixed material of colored drawing in accordance with the first embodiment of the present invention;

FIG. 4 shows a resultant multicolor plastic product made by the method for making multicolored plastic mixed material of colored drawing in accordance with a second preferred embodiment of the present invention;

FIG. 5 shows a resultant multicolor plastic product made by the method for making multicolored plastic mixed material of colored drawing in accordance with a third preferred embodiment of the present invention;

FIG. 6 shows a resultant multicolor plastic product made by the method for making multicolored plastic mixed material of colored drawing in accordance with a fourth preferred embodiment of the present invention;

FIG. 7 shows a resultant multicolor plastic product made by the method for making multicolored plastic mixed material of colored drawing in accordance with a fifth preferred embodiment of the present invention;

FIG. 8 shows a resultant two color plastic sole made by the method for making multicolored plastic mixed material of colored drawing in accordance with a sixth preferred embodiment of the present invention; and

FIG. 9 shows a resultant multicolor curved plastic board made by the method for making multicolored plastic mixed material of colored drawing in accordance with a ninth preferred embodiment of the present invention.

### DETAILED DESCRIPTION OF THE PREFERRED EMBODIMENTS

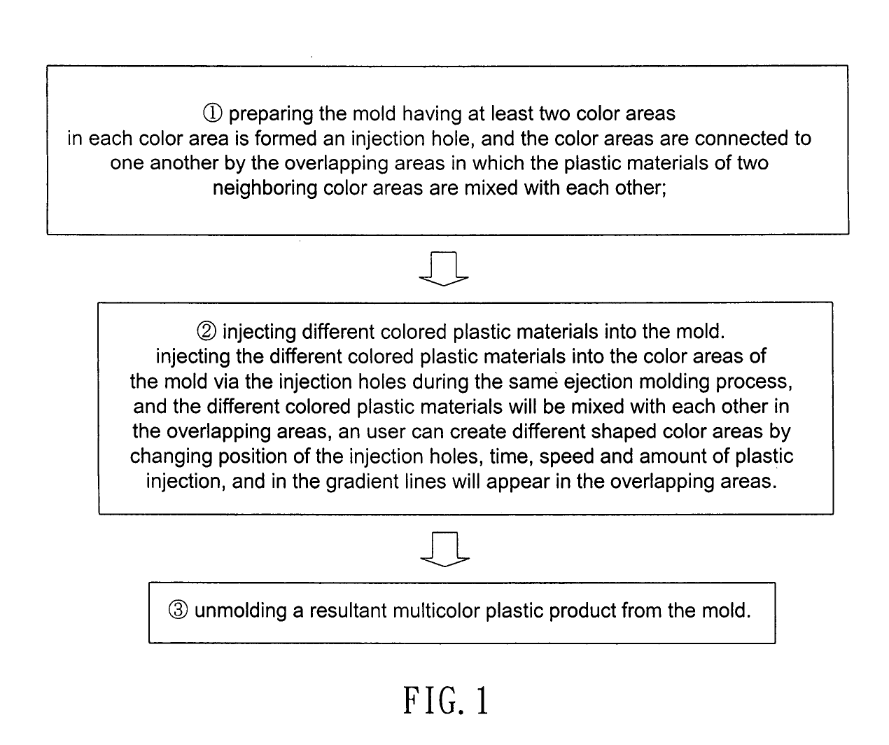

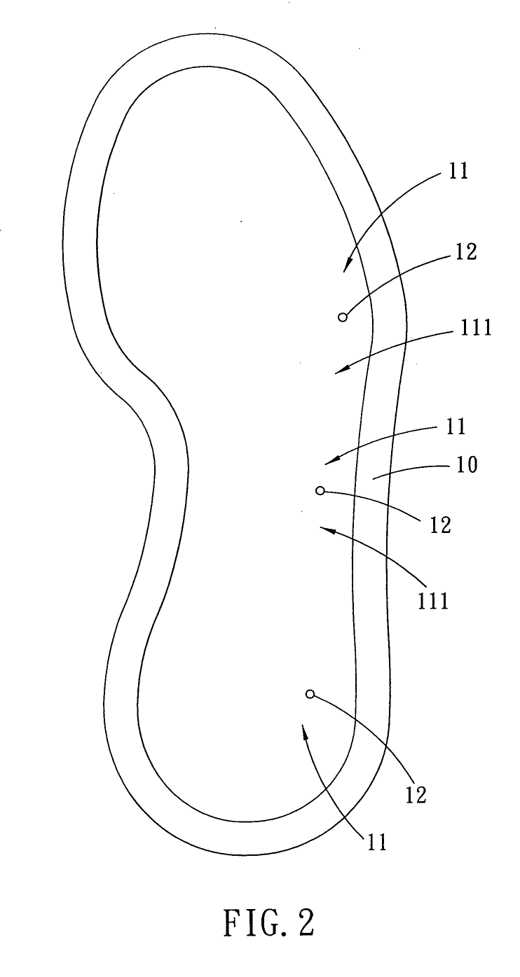

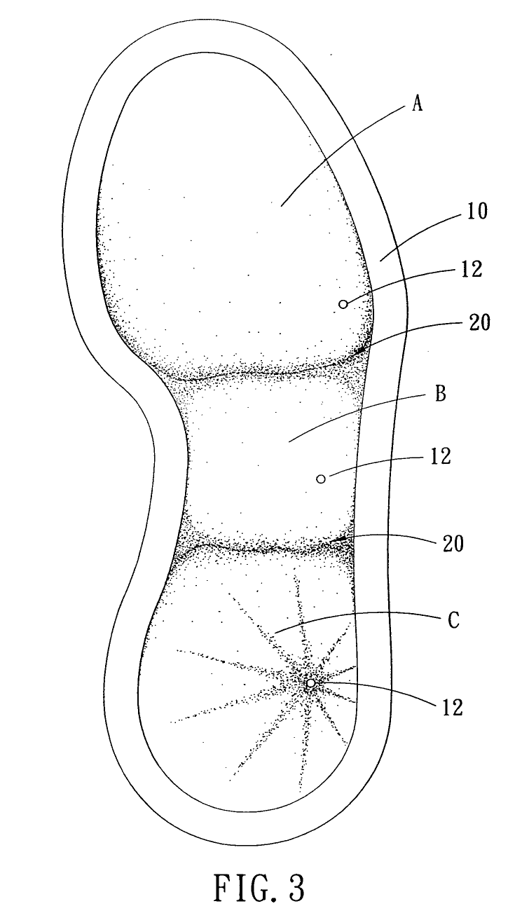

Referring to FIGS. 1-3, a method for making multicolored plastic mixed material of colored drawing in accordance with a preferred embodiment of the present invention is illustrated and comprises the following steps:

\textcircled{1} preparing a mold 10.

In the mold 10 are arranged three color areas 11, in each color area 11 is formed an injection hole 12, and the three color areas 11 are connected to one another by an overlapping area 111 in which the plastic materials of two neighboring color areas 11 are mixed with each other.

\textcircled{2} injecting different colored plastic materials into the mold.

injecting three different colored plastic materials A, B and C into the color areas 11 of the mold 10 via the injection holes 12 during the same ejection molding process, and the plastic materials A, B and C will be mixed with each other in the overlapping areas 111, so that a gradient line 20 formed by the mixture of the different colored plastic materials will be created between the plastic materials A and B, and between B and C. The user can create different shaped color areas 11 by changing the position of the injection holes 12, the time, the speed and the amount of plastic injection. And in the gradient lines 20 will appear in the overlapping areas 20.

\textcircled{3} unmolding a resultant multicolor plastic product from the mold.

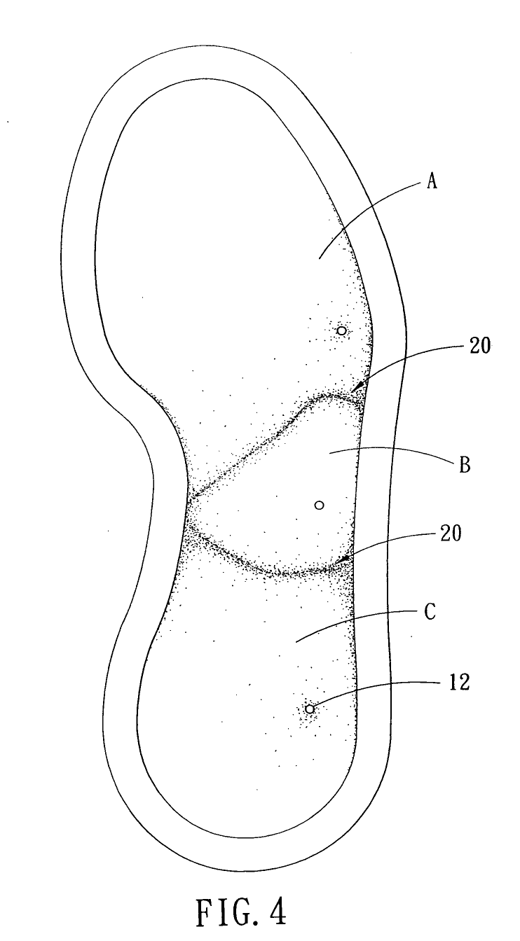

Referring to FIG. 4, a multicolor plastic product in accordance with a second proffered embodiment of the present invention is shown and it is produced by changing the time, the speed and the amount of the different colored plastic materials A, B and C injection, wherein the shape of the color areas 11 of the multicolor plastic product and the gradient lines 20 are different from those of the first embodiment.

The time, the speed and the amount of injection of the different colored materials A, B and C are as follows:

| | Plastic material A | | Plastic material B | | Plastic material C | |
|---|---|---|---|---|---|---|
| The first | | | | | | |
| embodiment | | | | | | |
| Amount of | 70 | g | 30 | g | 60 | g |
| injection | | | | | | |
| Time of | 2 | seconds | 1.5 | seconds | 1.8 | seconds |
| injection | | | | | | |
| Speed of | 31.8 | cm³/sec | 18.2 | cm³/sec | 30.3 | cm³/sec |
| injection | | | | | | |
| The second | | | | | | |
| embodiment | | | | | | |
| Amount of | 75 | g | 20 | g | 65 | g |
| injection | | | | | | |
| Time of | 2.1 | seconds | 1.2 | seconds | 2.0 | seconds |
| injection | | | | | | |
| Speed of | 32.5 | cm³/sec | 15.2 | cm³/sec | 29.5 | cm³/sec |
| injection | | | | | | |

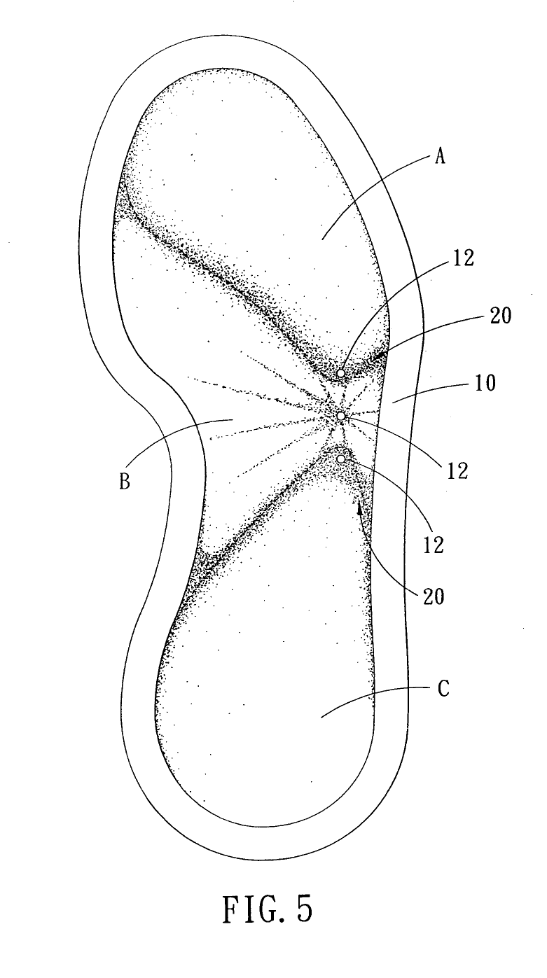

Referring to FIG. 5, which shows a multicolor plastic product in accordance with a third proffered embodiment of the present invention, wherein the injection holes 12 are located more closer to each other as compared with the previous embodiments. The change in the position of the plastic materials A, B and C and the color areas 11 creates a X-shaped gradient lines 20 in the overlapping area 111.

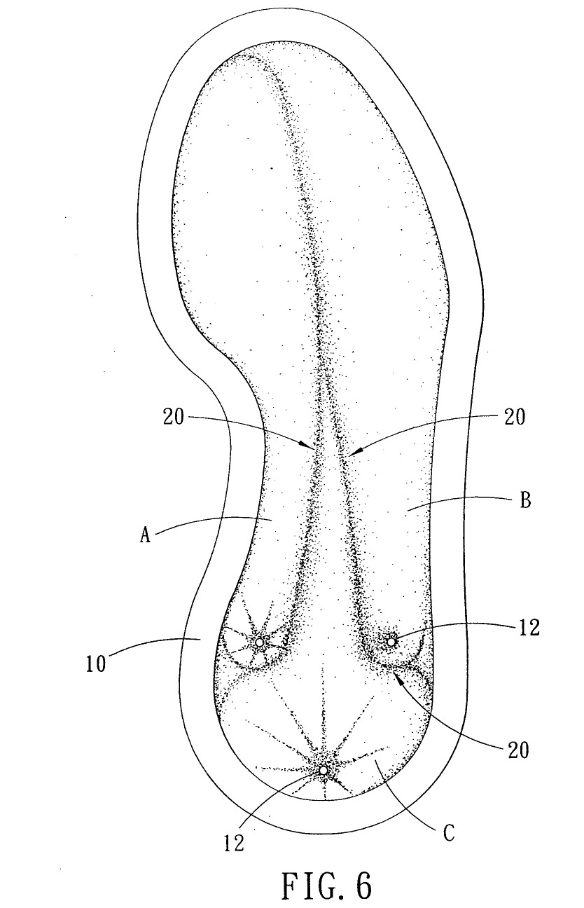

Referring to FIG. 6, which shows a multicolor plastic product in accordance with a fourth proffered embodiment of the present invention, wherein the injection holes 12 are located in the heel portion. The change in the position of the plastic materials A, B and C and the color areas 11 creates a V-shaped gradient lines 20 in the overlapping area 111.

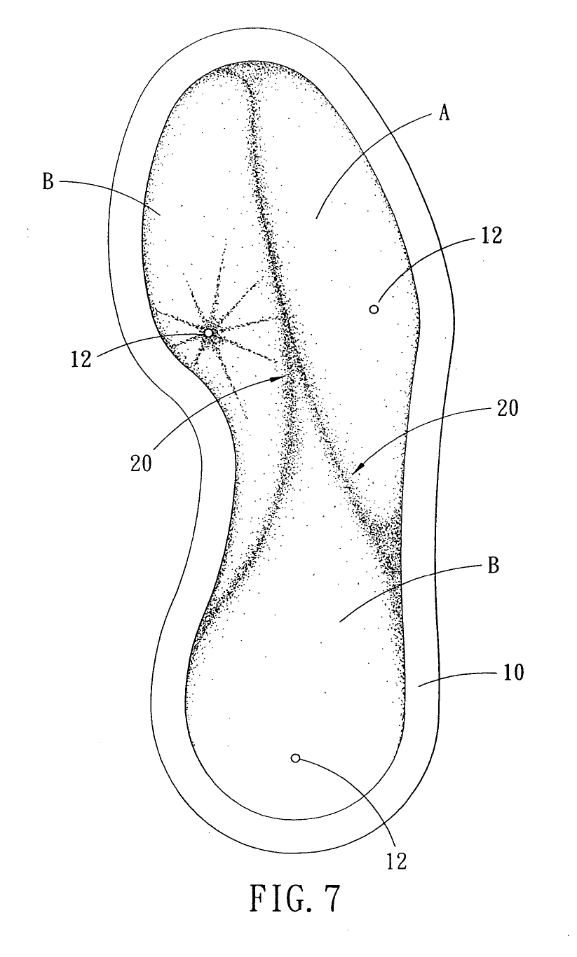

Referring to FIG. 7, which shows a multicolor plastic product in accordance with a fifth proffered embodiment of the present invention, wherein two injection holes 12 are located in the front portion of the sole and another injection hole 12 is located in the heel portion. The change in the position of the plastic materials A, B and C and the color areas 11 creates a V-shaped gradient lines 20.

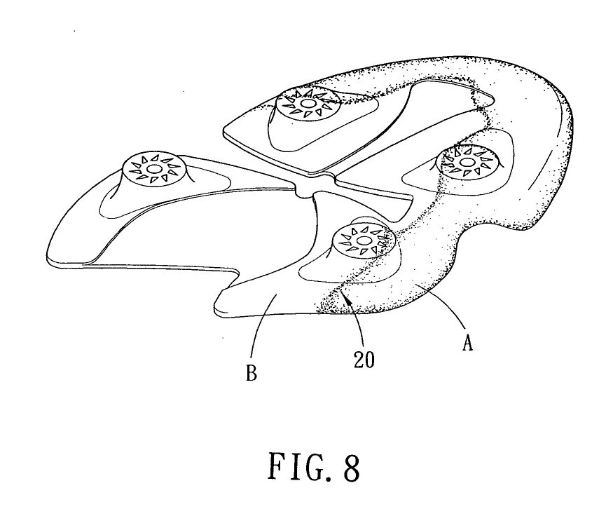

Referring to FIG. 8, which shows a two color plastic product in accordance with a sixth proffered embodiment of the present invention, wherein the two color plastic product is made by a mold having two color areas A and B, and the shape of the color areas and the gradient lines 20 also can be changed by changing the time, the speed and the amount of the colored plastic materials injection.

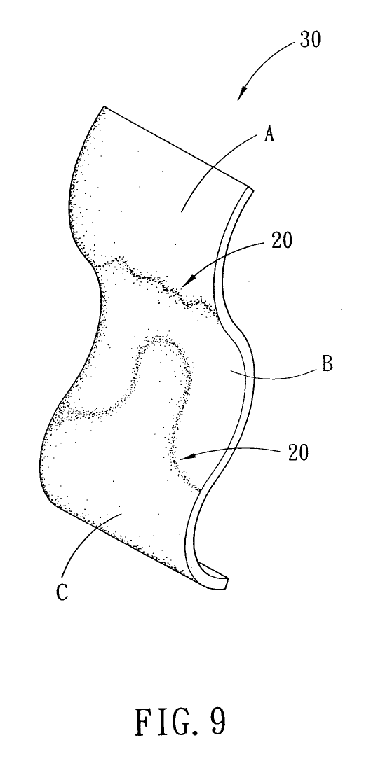

Referring to FIG. 9, which shows a curved multicolor plastic board in accordance with a seventh proffered embodiment of the present invention, wherein the curved multicolor plastic board is made by a mold having two three color areas A, B and C, and the shape of the color areas A, B and C and the gradient lines 20 also can be changed by changing the time, the speed and the amount of the colored plastic materials. The method of forming a multicolor plastic product is suitable for any plastic ejection molding process.

It will be noted that the technical characteristics of the present invention are as follows:

1. A multicolor plastic product can be formed in the same mold, and the shape of the color areas of the multiple plastic product can be changed by changing the time, the speed and the amount of the colored plastic materials injection.

2. When different molds are used, the shape of the color areas of the multiple plastic product can be changed by changing the time, the speed and the amount of the colored plastic materials injection or by changing the position and the amount of the injection holes.

Therefore, it not only can improve the appearance of the plastic product but also can reduce the mold development cost.

Since the time, the speed and the amount of the colored plastic materials injection or the position and the amount of the injection holes can be changed at any time according to needs, it creates more different types of gradient lines 20 and color areas 11. For example, the gradient lines 20 can be foggy gradient layer or non-straight lines made by the mixture of the different colored plastic material.

While we have shown and described various embodiments in accordance with the present invention, it should be clear to those skilled in the art that further embodiments may be made without departing from the scope of the present invention.

What is claimed is:

1. A method for making multicolored plastic mixed material of colored drawing comprising a step of injecting at least two different colored plastic materials into a mold during a same injection molding process, wherein at least two injection holes and color areas are arranged according to a predetermined pattern in order to create a multicolor plastic product with desired pattern, and the color areas are connected by a plurality of overlapping areas in which the plastic materials of two neighboring color areas are mixed with each other, after injection of the different colored plastic materials into the mold, different color areas each containing a different colored plastic material will be formed, and a gradient line formed by a mixture of the different colored plastic material will be created in the overlapping areas.

2. The method for making multicolored plastic mixed material of colored drawing as claimed in claim 1 further comprising:
\textcircled{1} preparing the mold having at least two color areas
in each color area is formed an injection hole, and the color areas are connected to one another by the overlapping areas in which the plastic materials of two neighboring color areas are mixed with each other;
\textcircled{2} injecting different colored plastic materials into the mold
injecting the different colored plastic materials into the color areas of the mold via the injection holes during the same ejection molding process, and the different colored plastic materials will be mixed with each other in the overlapping areas, an user can create different shaped color areas by changing position of the injection holes, time, speed and amount of plastic injection, and in the gradient lines will appear in the overlapping areas;
\textcircled{3} unmolding a resultant multicolor plastic product from the mold.

3. The method for making multicolored plastic mixed material of colored drawing as claimed in claim 1, wherein the gradient lines are non-straight lines made by the mixture of the different colored plastic material.

4. The method for making multicolored plastic mixed material of colored drawing as claimed in claim 2, wherein the gradient lines are non-straight lines made by the mixture of the different colored plastic material.

5. The method for making multicolored plastic mixed material of colored drawing as claimed in claim 2, wherein the gradient lines are foggy gradient layers made by the mixture of the different colored plastic material.
